(19) United States
(12) Patent Application Publication
(10) Pub. No.: US 2020/0220909 A1
(43) Pub. Date: Jul. 9, 2020

(54) METHOD AND APPARATUS FOR COMBINING METADATA AND CONTENT STREAM MANIFEST FILES FOR PROCESSING ON CLIENT DEVICES

(71) Applicant: INVIDI Technologies Corporation, Princeton, NJ (US)

(72) Inventors: Robert Booth, Princeton, NJ (US); Alden Lloyd Peterson, New Providence, NJ (US); Mike Festa, Princeton, NJ (US); Matthew Oyer, Princeton, NJ (US)

(21) Appl. No.: 16/600,262

(22) Filed: Oct. 11, 2019

Related U.S. Application Data
(60) Provisional application No. 62/744,535, filed on Oct. 11, 2018.

(51) Int. Cl. H04L 29/06

(52) U.S. Cl. CPC H04L 65/4069; H04L 65/604

(57) ABSTRACT

A method and apparatus are disclosed for preparing program data for delivery to internet-enabled client devices implementing a targeted advertising scheme. A data combining apparatus (100) and associated data are provided for generating a combined manifest file. The apparatus (100) includes a demultiplexer (104), a data message handler (102), an A/V segmenter (103), and a manifest and metadata combiner (104). A content stream (105) (e.g., MPEG-TS) may be received at demultiplexer (104) and separated into data messages (i.e., metadata) and A/V content. Data message handler (102) may process the data messages into data message files (106) which include metadata. A/V segmenter (103) may segment the A/V content into A/V file chunks and generate manifest files (107) which include PTSs. Manifest and metadata combiner (104) may merge the data message files (106) and manifest files (107) into combined manifest files (108).

### CROSS-REFERENCE TO RELATED APPLICATION

This application is a non-provisional of U.S. Provisional Application No. 62/744,535, entitled, “METHOD AND APPARATUS FOR COMBINING METADATA AND CONTENT STREAM MANIFEST FILES FOR PROCESSING ON CLIENT DEVICES,” filed on Oct. 11, 2018. The contents of the above-noted application are incorporated by reference herein as if set forth in full and priority to this application is claimed to the full extent allowable under U.S. law and regulations.

### FIELD OF THE INVENTION

The present invention relates generally to combining content stream messages (e.g., ad break information associated with a live video stream) with manifest files to be delivered to and processed by client devices for insertion of targeted advertisements in Over-the-top (“OTT”), Internet Protocol Television (“IPTV”), or other streaming content.

### BACKGROUND OF THE INVENTION

Traditionally, television programming is distributed through terrestrial, satellite, and cable television formats. In this regard, a content stream containing television shows, movies, advertisements, public service announcements, etc. is continuously transmitted and viewed in a substantially real-time manner as scheduled (in a “live” or “linear” manner) at a viewer's television.

In recent years, with the proliferation of digital television, alternative conduits for accessing television programming have emerged. Some of these are linear, in which the content stream is viewed in real-time similar to traditional systems, and others are non-linear (e.g., time-shifted viewing using a digital video recorder or “DVR”, video-on-demand, etc.). OTT and IPTV have both gained widespread appeal as delivery methods utilizing the Internet protocol over a packet-switched network. Generally, the difference between the two protocols is that OTT typically utilizes open internet channels whereas IPTV generally is offered over a dedicated infrastructure. Notably, both may be linear or non-linear. Furthermore, the present invention may be applicable in the context of any streaming format but for clarity is discussed primarily with reference to OTT and IPTV.

In the context of linear OTT and linear IPTV, a viewer may receive and view a content stream at substantially the same time as a viewer receiving the content stream in a traditional fashion. For example, a viewer receiving a satellite broadcast may be tuned into NBC to watch a television program while an OTT user may watch an identical NBC broadcast on an internet-enabled device (e.g., smartphone, tablet computer, PC, Smart TV, game console, etc.) at the same time. In this regard, television shows may be synchronized across thousands of devices accessing the stream via the internet.

Generally, in digital television, a content stream is embodied in a digital container format for transmission and storage. Although a variety of digital container formats exist and may be applicable in the context of the present invention (e.g., 3GP, AVI, Flash, etc.), MPEG-2 transport stream (“MPEG-TS”) is widely used as a standard container for digital broadcasting, Blu-Ray, etc. and therefore the present invention is discussed primarily in the context of MPEG-TS. An MPGE-TS may be simultaneously distributed via traditional means and alternative channels such as OTT and IPTV. In the latter regard, the MPEG-TS may be segmented into file chunks (e.g., 5-10 seconds each) for individual download to end-user devices. A manifest file may be created and subsequently accessed by or downloaded to the devices. Such a manifest file may provide the devices with addresses at which the file chunks may be retrieved as well as presentation time stamps (“PTSs”) for synchronization. In this regard, the manifest file is used by the client device to enable streaming playback of a content stream.

Broadcast network content or programming is commonly provided in conjunction with associated informational content or assets. These assets include advertisements, associated programming, public-service announcements, ad tags, trailers, weather or emergency notifications and a variety of other content, including paid and unpaid content. In this regard, asset providers (e.g., advertisers) who wish to convey information (e.g., advertisements) regarding services and/or products to users of the broadcast network often pay for the right to insert their information into programming of the broadcast network. For instance, advertisers may provide ad content to a network operator such that the ad content may be interleaved with a content stream during one or more ad breaks.

In order to achieve a better return on their investment, asset providers often try to target their assets to a selected audience that is believed to be interested in the goods or services of the asset provider. The case of advertisers on a cable television network is illustrative. For instance, an advertiser or a cable television network may target its ads to certain demographic groups based on, for example, geographic location, gender, age, income etc. Accordingly, once an advertiser has created an ad that is targeted to a desired group of viewers (e.g., targeted group) the advertiser may attempt to procure insertion times in the network programming when the targeted group is expected to be among the audience of the content stream.

In some broadcast networks (e.g., such as those in the United States), one or more ad cues (e.g., SCTE 35 or 104) may also be incorporated into the content stream. Such ad cues have allowed network platforms (e.g., local head ends) to identify upcoming ad breaks in the programming contained in the national feed. Accordingly, such local head ends may replace content within the national feed with an asset that is better suited for a local audience.

In recent years, technological advancements have enabled advertisers to target advertisements to more specific levels of granularity. In the case of addressable environments such as OTT or IPTV, different viewers of a given program, even within a particular network subdivision, may receive different ads while viewing the same channel and program. This allows ads to be targeted based on location parameters independent of network topology, demographics, psychographics, or other targeting parameters of interest to an advertiser. Households or an individual user or users may be targeted based on classification parameters inferred from interaction with a device, an identity or characteristics determined by sensors, information from network or third-party databases and/or other information sources including, but not limited to, past purchase data, browser history, credit report, income, gender, personal interests, etc. (collectively, “consumer data”).

In the context of OTT or IPTV, an ad cue which may be included in a manifest file may signal a device streaming an MPEG-TS to send a request to an ad decision engine. The ad decision engine may evaluate consumer data associated with the device to determine an appropriate asset for insertion during an upcoming ad break. In some instances, a selected advertisement may then be downloaded to the device. In other instances, a plurality of assets may be downloaded to the device in advance and the ad decision engine may instruct the device which asset to display and which assets to ignore or discard. In yet other instances, an ad decision engine may instruct the device to stream a particular asset by providing an address at which the asset may be streamed.

There are currently no known scalable solutions or standards that reliably enable targeted audio and/or video advertising in linear OTT and linear IPTV systems. For example, as mentioned above, current OTT client players will issue playlist requests to ad decision engines at the time of the ad break. Given the large number of devices that may be simultaneously streaming the same content stream, this can cause the ad decision server to become inundated with requests at or near the time of an ad break. Given the volume of requests, responses may not be served for an extended period or rejected altogether (e.g., timed-out). This presents a problem for live streaming in that targeted ad placement opportunities may be lost. Therefore, a scalable solution to ensure adequate and reliable responses from an ad decision engine is desirable.

### SUMMARY OF THE INVENTION

The present invention is directed to a method and apparatus for preparing program data for delivery to internet-enabled client devices implementing a targeted advertising scheme. A system is disclosed that separates an MPEG-TS into data messages and A/V content, modifies data messages, and combines modified content stream message data and content stream manifest files into combined manifest files (containing, inter alia, presentation time stamps or “PTSs”, ad break cues, etc.) based on relevant timestamps. The combined manifest files can be accessed and processed by client devices to download content and synchronize streaming of the content. Importantly, the present invention may enable the delivery of targeted audio/video advertisements to digital client devices in OTT and IPTV systems without overwhelming ad decision engines. In practice this invention may be utilized in other digital systems such as traditional digital cable or satellite delivery systems.

In an embodiment of the present invention, a system for modifying content stream messages for incorporation into manifest files is described. The system may comprise a demultiplexer configured to separate a content stream embodied in a transport stream into data messages (e.g., ad break cue metadata) and audio/video (“A/V”) content. The demultiplexer may be operatively connected to a data message handler and an A/V segmenter. The data message handler may receive the data messages separated from the transport stream by the demultiplexer and generate a data message file containing the relevant source metadata and PTSs. The data message file may contain data messages as originally received in the transport stream or the data message handler may modify the data messages. For example, the data message handler may modify the time stamp associated with an ad break cue or may insert an advance notice for a device to send a request to an ad decision engine. Such an advance notice may instruct a client device to send a request at a random time selected from within a window of specified times. In this regard, various client devices streaming the same content stream may select different random times such that requests are transmitted to the ad decision engine at different times. Alternatively, the data message handler may generate a plurality of data message files, each containing different times at which a request is to be sent. In this regard, different client devices may receive different data message files and may therefore send requests to the ad decision engine at different times.

The A/V segmenter may parse the A/V content into segments and generate a manifest file including PTSs. The system may further comprise a manifest and metadata combiner which is operatively interconnected to the data message handler and A/V segmenter. In this regard, the manifest and metadata combiner may receive a data message file and a manifest file and combine the data into a combined manifest file structured in accordance with the PTSs. Combined manifest files may be stored in a memory device of the system. Remote client devices (e.g., computers, wireless devices, televisions, set top boxes, etc.) may send a request to the system for a combined manifest file, in which case the combined manifest file may be accessed by or sent to the client device. Notably, the various features described as distinct components of the system may be combined into multifunctional components. For example, the functions of an A/V segmenter and data message handler may be performed by a single component. Additionally, various features and components may be embodied in hardware devices or the functions thereof may be performed by software-implemented modules disposed on a non-transient computer readable memory.

As mentioned above, in some instances, data messages may comprise ad break cues. Ad break cues may be received as a part of a content stream (e.g. MPEG-TS), processed by a cue handler and then combined, based on PTSs, with corresponding manifest files (that are generated by an A/V segmenter) to create new manifest files (i.e., combined manifest files). The combined manifest files may include both relevant ad break information and references to the associated A/V content.

In an aspect, combined manifest files may be processed by a client device completely within the context of a web browser or alternatively by a native application. Also, in some embodiments, instructions regarding request messages (e.g., video ad serving template or “VAST”) may be combined into a combined manifest file as described above so as to direct client devices to request ad playlists from a remote ad decision engine at random times based on the information provided in a combined manifest file. Alternatively or additionally, combined manifest files may altered between subsequent downloads to different client devices in order to specify staggered assigned times at which particular client devices are to send a VAST request message. In other words, a combined manifest file received at one client device may specify a different time for sending a VAST request message than a combined manifest file received by another client device.

In yet another embodiment, the present invention may include a method to combine metadata with manifest files to create combined manifest files for use by client devices. Initially, a demultiplexer may receive a transport stream including content stream content and associated data message(s) (e.g., metadata, ad break cues, etc.). The demultiplexer may separate the stream to pass metadata messages to one or more corresponding metadata handlers and to pass content data (e.g., A/V content) to an A/V segmenter. The metadata handler may create and update a metadata file to include relevant metadata including ad break cues source timestamps. The A/V segmenter may process the content data into file chunks and generate a manifest file that includes the source timestamps associated with each file chunk. A client device may request a combined manifest file from a combined manifest server. A manifest and metadata combiner may generate a combined manifest file that includes data regarding A/V file chunks and metadata aligned in sequence based on the source timestamps. Notably, the combined manifest file may be generated before or after the client device sends the request. The combined manifest server may send the combined manifest file to the client device. The client device may process the combined manifest file and request updated manifest files as needed.

### BRIEF DESCRIPTION OF THE DRAWINGS

For a more complete understanding of the present invention and further advantages thereof, reference is now made to the following Detailed Description, taken in conjunction with the drawings, in which:

FIG. 1 is a block diagram of an embodiment of a data combining apparatus for combining metadata and content stream manifest files.

FIG. 2 is a block diagram of an embodiment of a data combining apparatus for combining metadata and content stream manifest files wherein the metadata comprises ad break cue data.

FIG. 3 is a block diagram of an embodiment of a system utilizing a data combining apparatus for combining metadata and content stream manifest files.

FIG. 4 is a block diagram of a method of inserting advertisements into streamed content.

FIG. 5 is a flow chart of a method of combining metadata and content stream manifest files.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

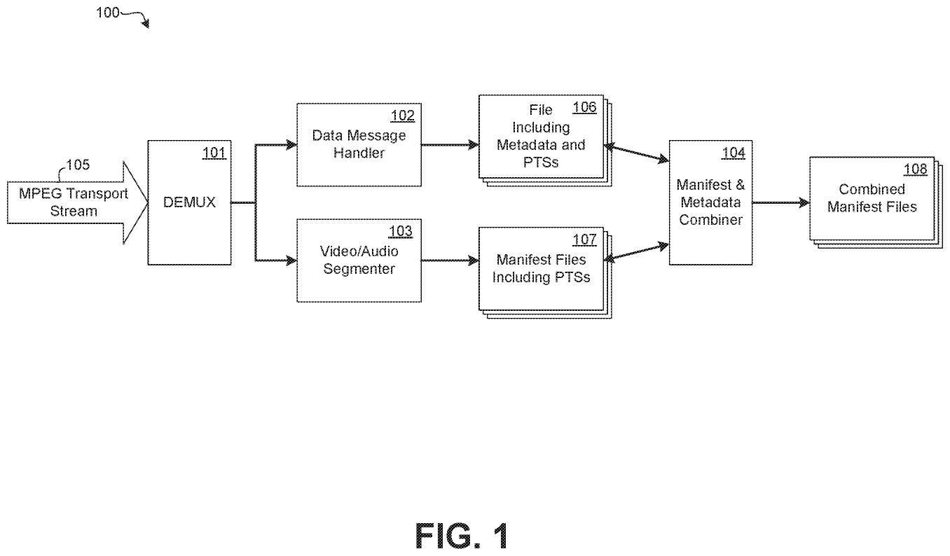

FIG. 1 illustrates a generic embodiment of a data combining apparatus 100 and associated data for generating a combined manifest file. The apparatus 100 includes a demultiplexer 104, a data message handler 102, an A/V segmenter 103, and a manifest and metadata combiner 104. A content stream 105 (e.g., MPEG-TS) may be received at demultiplexer 104 and separated into data messages (i.e., metadata) and A/V content. Data message handler 102 may process the data messages into data message files 106 which include metadata. A/V segmenter 103 may segment the A/V content into A/V file chunks and generate manifest files 107 which include PTSs. Manifest and metadata combiner 104 may merge the data message files 106 and manifest files 107 into combined manifest files 108. Combined manifest files 108 may be structured according to the PTSs contained in the data message files 106 and manifest files 107. Although described as multiple files, it is contemplated that a single data message file, a single manifest file, and/or a single combined manifest file may be utilized.

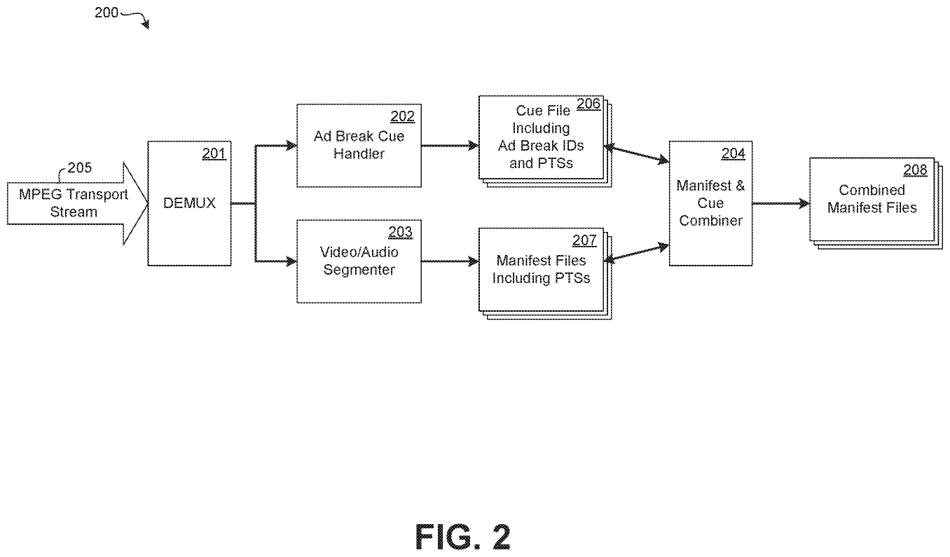

FIG. 2 illustrates an exemplary embodiment of a data combining apparatus 200 (may be a specific embodiment of a data combining apparatus 100 of FIG. 1) and associated data for generating a combined manifest file. In this embodiment, data messages may comprise ad break cue data. The data combining apparatus 200 may include a demultiplexer 204, an ad break cue handler 202, an A/V segmenter 203, and a manifest and cue combiner 204. A content stream 205 (e.g., MPEG-TS) may be received at demultiplexer 204 and separated into ad break cues and A/V content. Ad break cue handler 202 may process the ad break cues into cue files 206 which include PTSs. A/V segmenter 203 may segment the A/V content into A/V file chunks and generate manifest files 207 which include PTSs. Manifest and cue combiner 204 may merge the cue files 206 and manifest files 207 into combined manifest files 208. Combined manifest files 208 may be structured according to the PTSs contained in the cue files 206 and manifest files 207.

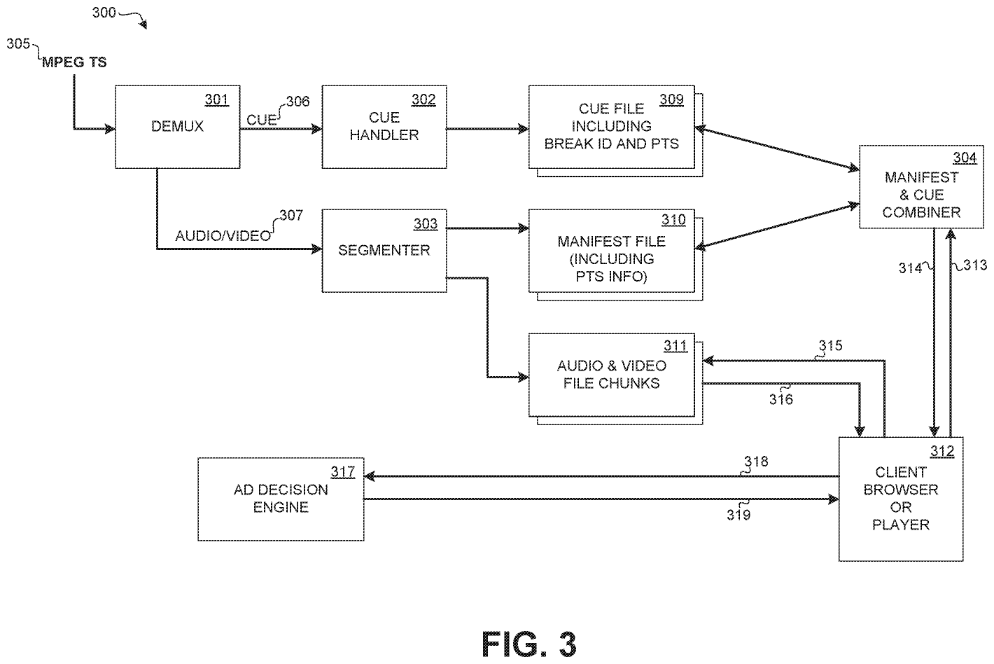

FIG. 3 illustrates a system 300 which utilizes a data combining apparatus (e.g., data combining apparatus 100 of FIG. 1) for combining metadata and content stream manifest files, and for accessing A/V content from a remote client device with targeted advertisements inserted. A data combining apparatus may be disposed at a server side location operated by a content provider or other party remote from the end user and client device. The components of the data combining apparatus may be disposed at a single location or may be geographically distributed. A data combining apparatus may comprise a demultiplexer 301, a cue handler 302, an A/V segmenter 303, and a manifest and cue combiner 304. Initially, a transport stream 305 comprising A/V content may be received at a demultiplexer 301. The demultiplexer 301 may separate the transport stream 305 into data messages (in this instance ad break cues 306) and A/V content 307. In some embodiments, the A/V content 307 may be separated into two distinct streams, one comprising audio and one comprising video. Ad break cues 306 may be received at cue handler 302 and the cue handler 302 may generate a cue file 309 which includes break ID and PTS information. Prior to generation of the cue file 309, ad break cue handler 302 may modify or insert instructions for a client device to retrieve an ad or an ad list at some point in time prior to an ad break cue.

A/V segmenter 303 may be operable to parse the A/V content 307 into A/V file chunks 311. The A/V segmenter 303 or a separate component in operative communication therewith with may generate a manifest file 310 which includes PTS data. The A/V content file chunks 311 may be stored locally on a memory device or may be transferred to a remote storage location. The manifest file 310 may also contain storage addresses associated with each A/V file chunk 311. Cue files 309 and manifest files 310 may be processed by manifest and cue combiner 304 to generate combined manifest files. Combined manifest files may be stored locally or remotely for access and/or retrieval by a client device 312 at a later time. Additionally or alternatively, a manifest and cue combiner 304 may act responsive to a request 313 sent from a client device 312, at which point the manifest and cue combiner 304 may retrieve a cue file 309 and a manifest file 310 from local or remote storage and generate a combined manifest file. One or more cue file 309 or manifest file 310 may be utilized in generation of a combined manifest file.

Upon receiving an input (e.g., user input via an input device such as a touchscreen), a client device 312 may initiate playback of selected content. A request 313 may be sent to the manifest and cue combiner 304 requesting a combined manifest file. Notably, a request 313 need not be sent directly to a manifest and cue combiner 304 but may be sent to a component of the system 300 in operative communication therewith. One or more combined manifest files may be transferred 314 (or generated and transferred) to the client device 312 in response to receipt of the request 304.

The client device 312 may access the contents of a combined manifest file to locate storage addresses associated with A/V file chunks 311. The client device 312 may then send requests 315 for A/V file chunks. Upon receipt of a request 315, one or more A/V file chunks may be transmitted 316 to the client device 312. In some embodiments, A/V file chunks 311 may be stored on a remote database, in which case the client device 312 may access the database to retrieve the file chunks.

Ad break cue data within a combined manifest file may instruct a client device 312 to send a VAST request message 318 to an ad decision engine 317. Instructions to send a VAST request message 318 may include a predetermined time at which the client device 312 is to send the VAST request message 318, such time being before an associated ad break, or the client device 312 may be instructed to send the VAST request message 318 at a random or predetermined time before the ad break. Upon receipt of a VAST request message 318, ad decision engine 317 may select an advertisement or advertisement package (or an advertisement may have previously been selected) based upon consumer data available to or stored at the decision engine 317 associated with the client device 312 and/or a user thereof and transmit the advertisement 319 or a list containing the advertisement 319 to the client device 312 for insertion into the A/V content at the associated ad break.

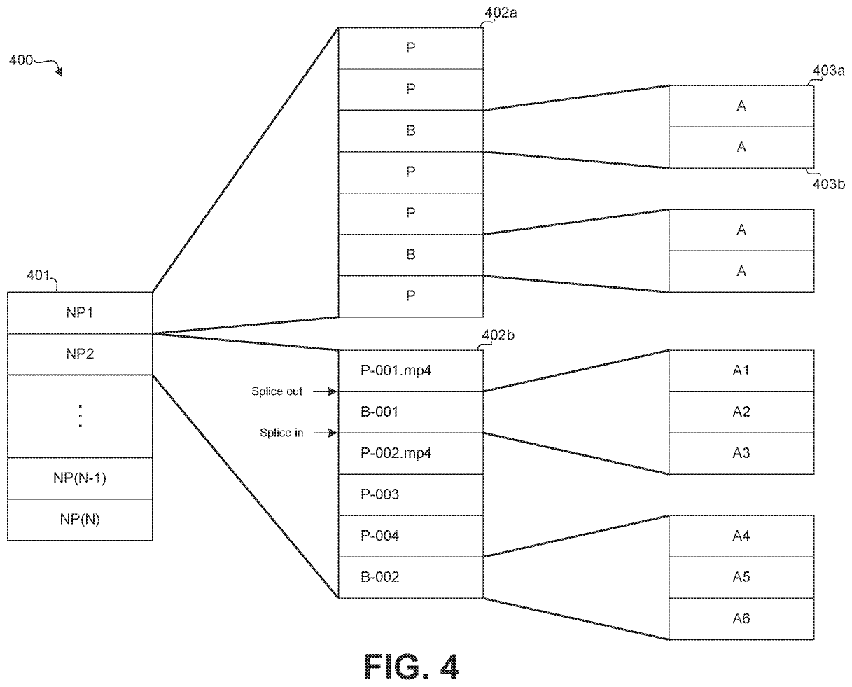

FIG. 4 illustrates a format 400 for inserting advertising advertisements into received A/V content. A client device (e.g., client device 312 of FIG. 3) may receive network programming 401 of a content stream in accordance with a combined manifest file. Each segment of network programming 401 depicted may represent a distinct television program, movie, or other content. For example, NP1 may be a first half-hour program and NP(N) may be another half-hour program. Each discrete network program may comprise a string 402a of A/V file chunks, denoted as “P” (e.g., audio and video file chunks 311 of FIG. 3), and ad breaks, denoted as “B.” A client device may receive A/V file chunks from one source (e.g., data combining apparatus) and ad content from another source (e.g., ad decision engine). Alternatively, all A/V content and ad content may be received from a single source and an ad decision engine may return a list of selected ads to the client device specifying which ads are to be inserted. The listed ads may already be downloaded to the client device or may be retrieved in response to receipt of the list.

As shown in string 402b, a client device may be operable to splice advertisements into ad breaks. Although shown as mp4 files, it is contemplated that ad and programming content may be received in any suitable format for playback of A/V content. In accordance with PTSs contained in combined manifest files, the client device may display advertisements 403a,b during ad breaks scheduled into the network programming. Some advertisements may be underlying network ads, e.g., 403a, which are received as A/V file chunks with the programming content while other advertisements, e.g., 403b, may be received from an ad decision engine or downloaded from another location in accordance with a list received from an ad decision engine.

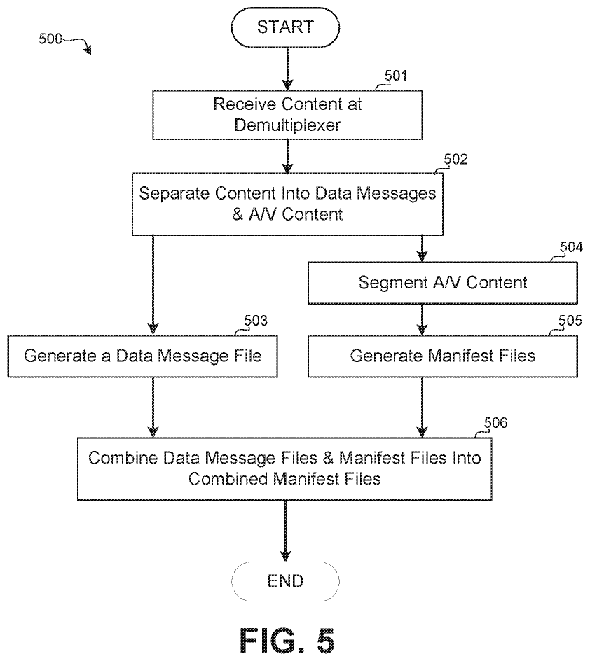

FIG. 5 is a flow chart of a method of combining metadata and content stream manifest files. The method 500 begins with receiving a transport stream of network content 501. The network content is separated into data messages and A/V content 502. A data message file containing data messages is generated and modified as appropriate 503 and A/V content is segmented into A/V file chunks 504. Based upon the segmenting of the file chunks, a manifest file may be generated 505. Finally, a combined manifest file is generated from the data message file and the manifest file 506.

The foregoing description of the present invention has been presented for purposed of illustration and description. Furthermore, the description is not intended to limit the invention to the form disclosed herein. Consequently, variations and modifications commensurate with the above teachings, and skill and knowledge of the relevant art are within the scope of the present invention. The embodiments described herein above are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

1. A data combining apparatus comprising:
a demultiplexer configured to receive a content stream and separate the content stream into metadata and audio and video (A/V) content;
a data message handler configured to receive metadata from the demultiplexer and generate a data message file;
an A/V segmenter configured to segment the A/V content into A/V file chunks; and
a manifest and metadata combiner configured to merge the data message file and manifest file into a combined manifest file.

2. The data combining apparatus of claim 1, wherein the data message file comprises presentation time stamps (PTSs) corresponding to the content stream.

3. The data combining apparatus of claim 2, wherein the A/V segmenter is further configured to generate a manifest file containing PTSs.

4. The data combining apparatus of claim 3, wherein the manifest file comprises storage addresses associated with the A/V file chunks.

5. The data combining apparatus of claim 4, wherein the combined manifest file contains PTSs corresponding to the content stream.

6. The data combining apparatus of claim 5, wherein data stored within the combined manifest file is organized based upon PTSs associated with the content stream.

7. The data combining apparatus of claim 6, wherein the metadata comprises ad break cue information.

8. The data combining apparatus of claim 7, wherein the data message handler is an ad break cue handler and the data message file comprises at least one break ID associated with an ad break scheduled within the content stream.

9. The data combining apparatus of claim 8, wherein the ad break cue handler is configured to modify ad break cue information to cause a first client device streaming the content stream to transmit a request to an ad decision engine at a first time and a second client device streaming the content stream to transmit a request to the ad decision engine at a second time.

10. The data combining apparatus of claim 9, further comprising a client device configured to receive a combined manifest file.

11. The data combining apparatus of claim 10, further comprising an ad decision engine configured to receive an ad request for an ad list from a client device and transmit an ad list in response to receipt of the ad request.

12. The data combining apparatus of claim 11, wherein the client device is configured to send the ad request as a function of processing data contained in the combined manifest file.

13. A client device configured to:
transmit a request for a combined manifest file wherein the manifest file comprises:
storage addresses and PTS data of a plurality of A/V video chunk files;
break ID and PTS data corresponding to scheduled ad breaks in a content stream; and
instructions, inserted by a data message handler, for a client device to send an ad request to an ad decision engine;
receive the combined manifest file;
read the combined manifest file;
transmit, in accordance with the combined manifest file, a request for at least one of the plurality of A/V video chunk files;
transmit, in accordance with the combined manifest file, the ad request for a list of ads to be inserted into the content stream;
receive the list of ads;
insert at least one ad listed in the list of ads during a corresponding ad break in the content stream.

14. A method of combining metadata and manifest files comprising:
receiving a transport stream of network content;
separating the network stream into data messages and A/V content;
generating a data message file containing content from the data messages;
segmenting the A/V content into A/V file chunks;
generating a manifest file comprising storage location addresses associated with the A/V file chunks;
generating a combined manifest file comprising data from the data message file and the manifest file.

15. The method of claim 14, further comprising:
inserting, into the data message file, instructions for a client device to send an ad request to an ad decision engine at a specified time.

16. The method of claim 14, further comprising:
inserting, into the data message file, instructions for a client device to send an ad request to an ad decision engine at a random time occurring within a specified time window.

17. The method of claim 14, further comprising:
inserting, into the combined manifest file, instructions for a client device to send an ad request to an ad decision engine at a specified time.

18. The method of claim 14, further comprising:
inserting, into the combined manifest file, instructions for a client device to send an ad request to an ad decision engine at a random time occurring within a specified time window.
